(19) United States
(12) Patent Application Publication
(10) Pub. No.: US 2015/0015149 A1
(43) Pub. Date: Jan. 15, 2015

(54) LED Control Method and Apparatus

(71) Applicant: Zhijun Zhang, Beijing (CN)

(72) Inventor: Zhijun Zhang, Beijing (CN)

(21) Appl. No.: 13/939,354

(22) Filed: Jul. 11, 2013

(51) Int. Cl. H05B 33/08

(52) U.S. Cl. CPC H05B 33/0821; H05B 33/0809
USPC 315/192

(57) ABSTRACT

An LED control circuit designed for providing stable voltage to LED loads, which is comprised of a bridge rectifier connected with the power supply, at least one LED branch circuit comprised of LED control units in series connection with a current-regulating element. Each LED control unit is comprised of a zener diode parallelly connected with LED working elements made of an LED and a serially connected current limiting resistor. The forward voltage drop of the zener diode closely approximates the desired working voltage of the LED loads, and thus each LED control unit plays the role of a voltage regulator. When voltage of an LED control unit is below the stabilized voltage of the zener diode, the brightness of LED is continuously adjustable. When an LED branch circuit is put under the control of a constant current control module, the current flowing through each LED can be stabilized.

### TECHNICAL FIELD

The present invention relates to an LED control circuit designed for providing stable voltage to LED loads. The LED control circuit is comprised of a bridge rectifier connected with the power supply, one or more LED branch circuits in parallel connection, each branch circuit comprising one or more LED control units in series connection with a current-regulating element, either a current-limiting resistor or a constant current control module, which plays the role of controlling the current flowing through the LED branch circuit. Each LED control unit is comprised of a zener diode parallelly connected with one or more LED working elements. Each LED working element comprising an LED and a serially connected current limiting resistor, which plays the dual function of limiting the current flowing through the LED and providing a negative feedback upon the current.

### BACKGROUND OF THE INVENTION

A light-emitting diode (LED) is a semiconductor light source. When an LED is switched on, electrons are able to recombine with holes within the device, releasing energy in the form of photons. The color of the light emitted (corresponding to the energy of the photon) is determined by the energy band gap of the semiconductor. LEDs present many advantages over incandescent light sources including lower energy consumption, longer lifetime, improved physical robustness, smaller size, and faster switching. However, LEDs powerful enough for room lighting require more precise current and heat management than compact fluorescent lamp sources of comparable output.

Red-light-emitting diodes and high-brightness-yellow-light-emitting diodes generally work under a forward working voltage of approximately 2.0 V. Green- or white-light-emitting diodes require a forward working voltage of approximately 3.0 V. The forward working current of low-power LEDs is normally between 15 to 25 mA. To meet the normal working condition of LEDs, an LED power control circuit needs to meet the following two requirements: first, providing a voltage that falls within the range of the forward working voltage; second, providing a current that falls within the range of the forward working current.

At present, designs of LED power supply rely on all kinds of voltage transformers and/or stable-voltage, constant-current power supplies to meet the working condition of LEDs. However, due to the reactive power loss and low efficiency of voltage transformers and power consumption of stable-voltage power supplies, the ratio between LED load power consumption and overall power consumption of LED power supply is merely 1 to 3. Moreover, voltage transformer as an inductive load has relatively low power factor, causing inductive load to certain extent. cl SUMMARY OF THE INVENTION

It is an objective of the present invention to provide an LED control circuit that overcomes the dependence on voltage transformers and/or stable-voltage, constant-current power supplies to provide LED loads the ideal working condition so that LED loads can work with a higher power efficiency under the same light intensity and more stably.

The present invention utilizes an LED control unit to function as a voltage-stabilizer. The LED control unit is typically comprised of a zener diode parallelly connected with an LED working element that includes an LED and a serially-connected current-limiting resistor, which plays the dual function of limiting and providing a negative feedback upon the current flowing through the LED.

Based on the foregoing concepts, the LED control unit can be expanded to include multiple working elements. The maximum number of LED working elements that can be included in an LED control unit shall be determined by the rated current that can flow through the zener diode. This guarantees that the LED control unit can work stably even if one or more LEDs are broken. Multiple LED control units can be serially connected and put under the control of a current-limiting resistor or constant current control module. The circuit resulted is called LED branch circuit.

The LED control circuit presently disclosed is comprised of a bridge rectifier connected to the power supply and one or more LED branch circuits in parallel connection. Each LED branch circuit has a current-limiting resistor or constant current control module to control the current of the circuit. In one embodiment a constant current control module is used in each LED branch circuit to stabilize the current flowing through the branch circuit within a narrow range.

By adopting the LED control circuit presently disclosed, there is no longer reliance on voltage transformers, resistors or capacitors to stabilize LED working voltage. Moreover, when constant current control modules are integrated in the LED control circuit, the ideal LED working condition of stabilized voltage and constant current is realized. A constant current module keeps the working current within a certain range, while the voltage of the constant current module varies according to the variation of the voltage of the power source. Because of the high power efficiency of LED control units, there is no heat-generating element in the whole LED control circuit. Therefore, the LED control circuit can work stably and reliably.

### BRIEF DESCRIPTION OF THE DRAWINGS

FIG. 1 illustrates an LED control unit, which is comprised of a zener diode (“Z”) in parallel connection with an LED working element, which is comprised of an LED (“LED”) and a current-limiting resistor (“R”) in series connection.

FIG. 2 illustrates an LED control unit which includes three LED working elements.

FIG. 3 illustrates an LED control circuit, which is comprised of a bridge rectifier connected to the power supply, two LED branch circuits, each having 70 LED control units in series connection and one current-limiting resistor (“R₁” and “R₂”).

FIG. 4 illustrates an LED control circuit having two LED branch circuits, each LED branch circuit including 60 serially connected LED control units and a constant current control module (“CC₁” and “CC₂”).

FIG. 5 illustrates a control unit that does not include any LED and is used merely to share voltage drop.

### DETAILED DESCRIPTION OF THE INVENTION

The present invention is now described with reference to the drawings. The examples used herein are only for the purposes of illustration, they shall not be interpreted as to limit the scope of the claim of the invention.

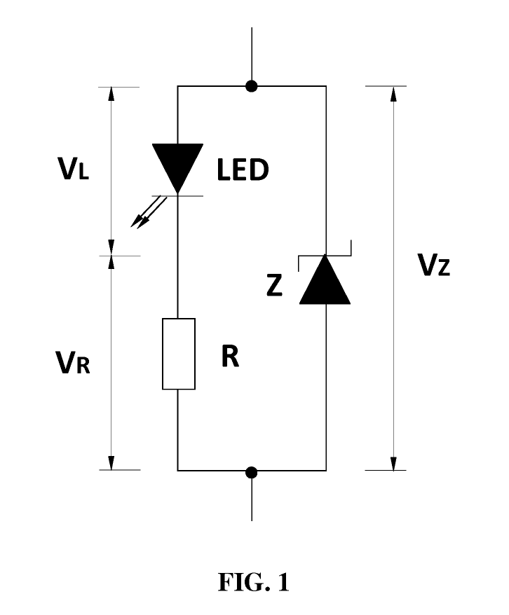

FIG. 1 illustrates an example of the LED control unit in its simplest form. As the voltage over the zener diode (V_{Z}) equals to the sum of the voltage over the LED (V_{L}) and the voltage over the current-limiting resistor (V_{R}),

V_{Z}=V_{L}V_{R}

V_{Z} must be bigger than V_{L}. The zener diode is selected based on its forward voltage drop so as to closely approximate the desired working voltage of the LED. Because of the voltage-ampere characteristics of the zener diode, the LED control unit described herein is able to provide a consistent working current to the LED by stabilizing the voltage over the LED. Other element or circuit may be used in place of the zener diode as long as it provides a stabilized voltage closely approximating the desired working voltage of the LED being controlled.

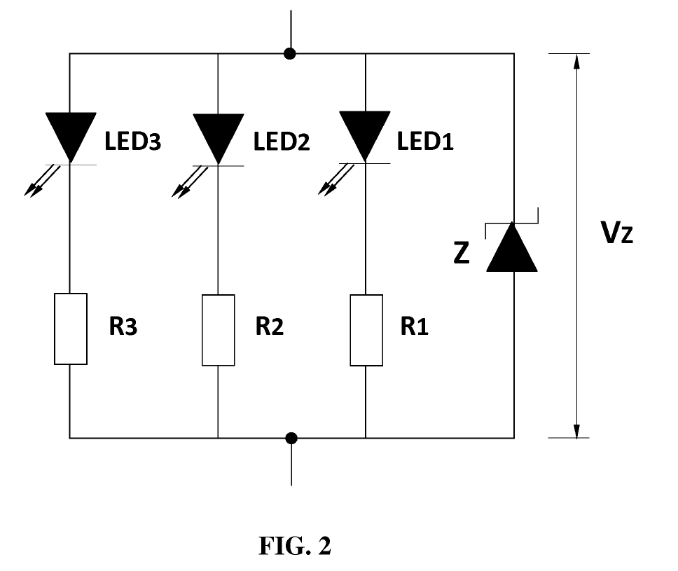

Based on the foregoing concepts, the LED control unit can be expanded to include multiple working elements. In one embodiment of the present disclosure, three working elements in parallel connection are put under the control of one zener diode (FIG. 2). The power consumption of the zener diode is very important. The maximum number of LEDs that can be included in the working element is determined by the rated current that can flow through the zener diode (I_{Z}). This guarantees that the whole circuit can work stably even if one or more LEDs are broken.

For an LED control unit to work properly, parallelly connected LED lights shall have a consistent junction voltage drop. Otherwise, different LEDs would require the installation of different current-limiting resistors, causing inconvenience to mass production. When voltage of an LED control unit reaches or exceeds the stabilized voltage of the zener diode, the zener diode plays the role of a voltage stabilizer. When voltage of an LED control unit is below the stabilized voltage of the zener diode, V_{L} follows the changes of the voltage of the power source. The brightness of the LED is therefore continuously adjustable.

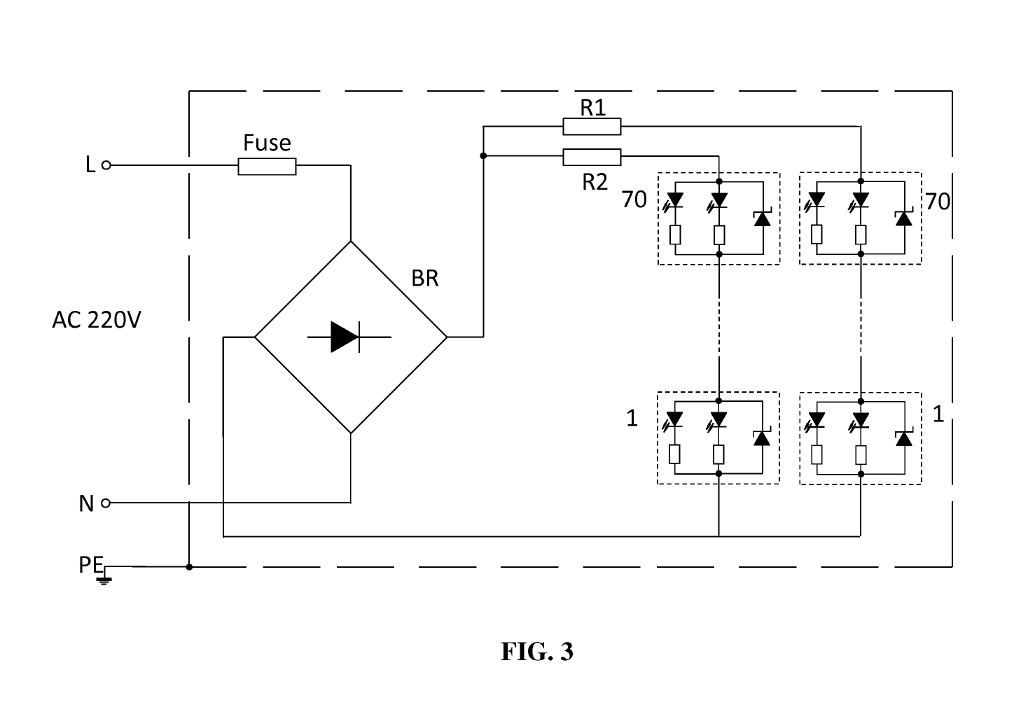

Multiple LED control units can be serially connected and put under the control of a current-regulating element, such as a current-limiting resistor or constant-current control module. FIG. 3 illustrates an embodiment of the LED control circuit that includes two LED branch circuits, each circuit having 70 LED control units in series connection with a current-limiting resistor. Each LED control unit has two parallelly connected LED working elements (FIG. 3). The current flowing through each LED is 17 mA, the current flowing through each zener diode is 4 mA, and the total current flowing through each LED control unit is 38 mA. The key to the overall design is the selection of the current-limiting resistors R₁ and R₂. Low-power-consumption resistors can be used if the total current of the whole circuit is tightly regulated. When AC/DC power source of 220 V is used, the maximum number of LEDs that can be included in one LED branch circuit is between 52 and 82. When AC/DC power source of 110 V is used, the maximum number of LEDs that can be included in one LED branch circuit is between 26 and 40.

To make the working current of an LED control circuit within a desired range, a constant current control module may be integrated into each LED branch circuit. To this end, a 45 mA/50 V constant-current control module is tested, which shows a flat current curve, between a narrow range from 23 mA to 27 mA, when the voltage varies from 1.5 V to 30 V. The current variation does not exceed 4 mA. Based on the characteristics of this constant-current control module, a target working current can be set at 25 mA. An LED control circuit demonstrates the optimal current stabilization at this current and works stably and reliably.

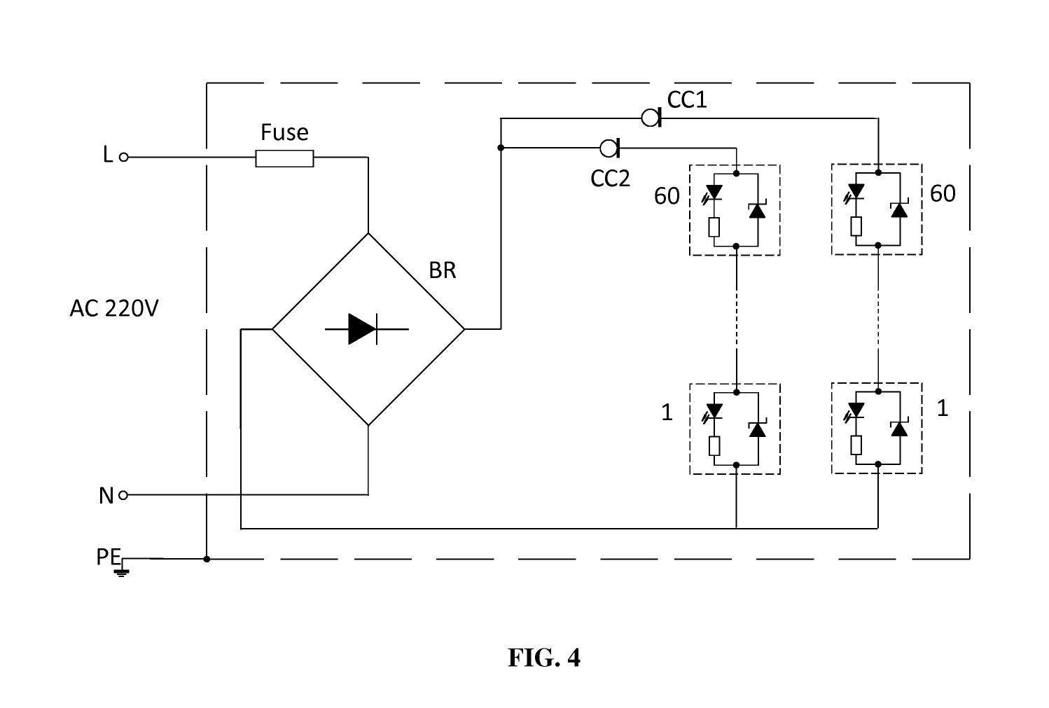

FIG. 4 illustrates an LED control circuit including two LED branch circuits, each put under the regulation of a constant-current control module. To achieve optimal working condition, the working current flowing through the LED control unit (I_{L}) can be adjusted to what is desired. For each LED, the voltage (V_{L}) is relatively stable, and the actual power output of the LED is hence controlled by the working current (I_{L}). Therefore, I_{L} can be adjusted to make the LED working at its optimal optical power output. For each LED control unit, I_{L} shall be maximized and I_{Z} shall be minimized so that the LED can work under the optimal condition.

Because the LED control circuit presently disclosed works under a broad range of voltage, AC/DC 130-265 V (220 V) or 65-130 V (110 V), a continuously adjustable brightness can be achieved before the voltage of each zener diode reaches the stabilized voltage. Due to the unique structure of LED control circuit, when voltage of the power source increases, the voltage increase is evenly shared by all of the LED control units that are in series connection. Therefore, all LEDs uniformly adjust their brightness.

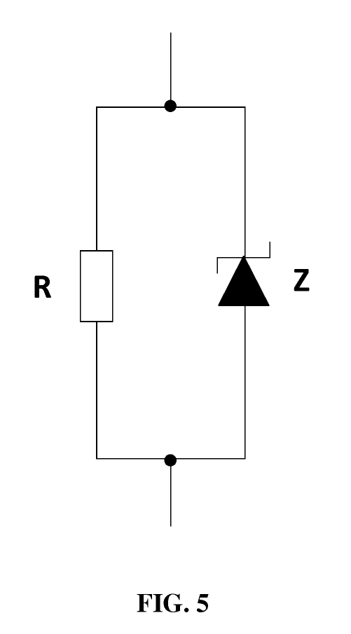

In summary, the LED control method and apparatus presently disclosed is based on the following principles: 1) the current flowing through an LED control unit or LED branch circuit shall be set within the regulation range of the constant current control module or be regulated by a constant-limiting resistor; 2) I_{L} and V_{z} shall be controlled; and 3) the total number of LEDs shall be controlled. When fewer LED control units are desired for the minimum number of LED control units required for a particular LED branch circuit, any number of voltage-dropping units can be integrated to make up the minimum number of LED control units required. FIG. 5 illustrates a voltage-dropping unit, comprised of a zener diode in parallel connection with a current-limiting resistor.

The LED control circuit presently disclosed has neither an inductive device nor a capacitor. Its capacitance is determined by the junction capacitance of the LEDs. The LED control circuit causes little reactive power loss. COS Φ≈1. Because there is no power or heat-generating element in the whole circuit, the LED control circuit can work stably and reliably for a long time.

The LED control circuit disclosed in the present invention can be mounted on the surface of a PCB through the SMT bounding processing. The end product can be as small as a circuit board with no need for any auxiliary circuit, making it extremely convenient to install and maintain. After a simple waterproof treatment, the product can work under water.

What is claimed is:

1. A method or apparatus of stabilizing the voltage of LED loads, comprising:
a zener diode; and
at least one LED working element parallelly connected thereto, each LED working element comprising an LED and a current limiting resistor in series connection thereto.

2. The method or apparatus of claim 1 wherein said zener diode has a forward voltage drop closely approximates the working voltage of the LED of each LED working element.

3. The method or apparatus of claim 1 or 2 wherein the number of LED working elements is determined by the rated current of the zener diode parallelly connected thereto.

4. A method or apparatus of providing constant current and stable voltage to LED loads, comprising:
a bridge rectifier connected with the power supply; and
at least one LED branch circuit parallelly connected thereto, each LED branch circuit comprising a current-regulating element, wherein said current-regulating element is a current-limiting resistor, constant current tube or constant current control module, and
at least one LED control unit in series connection thereto, each LED control unit comprising a zener diode parallelly connected with at least one LED working element, each LED working element comprising an LED and a current-limiting resistor in series connection thereto.

5. The method or apparatus of claim 4 wherein said zener diode has a forward voltage drop closely approximates the working voltage of the LED of each LED working element.

6. The method or apparatus of claim 4 or 5 wherein the number of LED working elements in each LED control unit is determined by the rated current of the zener diode parallelly connected thereto.
